(19) United States
(12) Patent Application Publication
(10) Pub. No.: US 2012/0198833 A1
(43) Pub. Date: Aug. 9, 2012

(54) GRAVITY AND BUOYANCY ENGINE

(76) Inventor: Kent Francis, Oberlin, PA (US)

(21) Appl. No.: 13/365,458

(22) Filed: Feb. 3, 2012

Related U.S. Application Data
(60) Provisional application No. 61/439,139, filed on Feb. 3, 2011.

(51) Int. Cl. F03B 17/00

(52) U.S. Cl. 60/496

(57) ABSTRACT

One example embodiment includes a gravity and buoyancy engine. The gravity and buoyancy engine includes a ball drop, wherein the ball drop is configured to release a ball to fall under the force of gravity. The gravity and buoyancy engine also includes an energy converter, wherein the energy convertor is configured to convert the energy of the falling body into energy that can be output from the gravity and buoyancy engine. The gravity and buoyancy engine further includes a ball reset, wherein the ball reset is configured to lift the ball to the initial release point.

### CROSS-REFERENCE TO RELATED APPLICATIONS

This application claims the benefit of and priority to U.S. Provisional Patent Application Ser. No. 61/439,139 filed on Feb. 3, 2011, which application is incorporated herein by reference in its entirety.

### BACKGROUND OF THE INVENTION

The promise of renewable energy has proved to be quite elusive. Despite massive investments both by private entrepreneurs and by governments, renewable energy continues to produce only a small fraction of the energy used both in America and worldwide. The problems with most renewable energy sources are similar to one another. Because of these problems, fossil fuels continue to provide the vast majority of energy available for consumption.

First, they depend on conditions which may or may not exist at any given time. For example, even in areas that experience lots of sun, there are still times in any location when it is dark and the solar panels do not receive sunlight. This reliance on environmental conditions means that the renewable energy source has great variability in the amount of energy produced. Because of this drawback, fossil fuel sources are often required as primary energy sources and renewable sources remain a backup or secondary energy source.

Second, most renewable energy sources require large scales to be efficient. That is, they are more efficient the more energy they produce. A single wind turbine, for example, produces electrical output. However, it is much more efficient to have an entire wind farm with multiple wind turbines providing electrical output. A large part of the reason for this is that a large amount. of electrical power is more efficiently transported than small amounts of electrical power. Because renewable power sources are often located remotely from the area that they serve, the electrical power must be transported. However, a portion of this is also due to the renewable sources themselves. Wind turbines require a proportionally smaller amount of energy to overcome friction the larger the turbine becomes.

Third, the production of the devices to harness renewable energy are often expensive to manufacture. Solar panels, for example, often require rare earth metals that are expensive to acquire. Because of this, the energy savings must be large in order to justify the cost of installing the devices to harness the renewable energy.

Accordingly, there is a need in the art for a renewable energy source that can produce a constant electrical output. In addition, there is a need in the art for a renewable energy source that works on small scales, allowing it to be used “on site.” Further, there is a need in the art for a renewable energy source that is cheap to manufacture.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a gravity and buoyancy engine. The gravity and buoyancy engine includes a ball drop, wherein the ball drop is configured to release a ball to fall under the force of gravity. The gravity and buoyancy engine also includes an energy converter, wherein the energy convertor is configured to convert the energy of the falling body into energy that can be output from the gravity and buoyancy engine. The gravity and buoyancy engine further includes a ball reset, wherein the ball reset is configured to lift the ball to the initial release point.

Another example embodiment includes a gravity and buoyancy engine. The gravity and buoyancy engine includes a ball drop. The ball drop is configured to release a buoyant ball to fall under the force of gravity. The ball drop includes a ball ramp, wherein the ball ramp is configured to release the buoyant ball. The ball drop also includes a drop tube, wherein the drop tube is configured to receive the buoyant ball from the ball ramp and direct the path of the falling buoyant ball. The gravity and buoyancy engine also includes a drive wheel. The drive wheel is configured to receive the falling buoyant ball from the drop tube and convert the kinetic energy of the falling buoyant ball to rotational energy, wherein the rotational energy is converted to electrical energy which is output from the gravity and buoyancy engine. The gravity and buoyancy engine further includes a ball reset. The ball reset includes a buoyant column, wherein the buoyant column is configured to lift the buoyant ball and a ball lift, wherein the ball lift is configured to move the buoyant ball from the buoyant column to the ball ramp.

Another example embodiment includes a gravity and buoyancy engine. The gravity and buoyancy engine includes a first ball drop. The first ball drop is configured to release a buoyant ball to fall under the force of gravity. The first ball drop includes a first ball ramp, wherein the first ball ramp is configured to release the buoyant ball. The first ball drop also includes a first drop tube, wherein the first drop tube is configured to receive the buoyant ball from the first ball ramp and direct the path of the falling buoyant ball. The gravity and buoyancy engine also includes a first drive wheel. The first drive wheel is configured to receive the falling buoyant ball from the first drop tube and convert the kinetic energy of the falling buoyant ball to rotational energy, wherein the rotational energy is converted to electrical energy which is output from the gravity and buoyancy engine. The gravity and buoyancy engine further includes a second ball drop. The second ball drop is configured to release a buoyant ball to fall under the force of gravity. The second ball drop includes a second ball ramp, wherein the second ball ramp is configured to receive a buoyant ball from the first drive wheel. The second ball drop also includes a second drop tube, wherein the second drop tube is configured to receive the buoyant ball from the second ball ramp and direct the path of the falling buoyant ball. The gravity and buoyancy engine additionally includes a second drive wheel. The second drive wheel is configured to receive the falling buoyant ball from the second drop tube and convert the kinetic energy of the falling buoyant ball to rotational energy, wherein the rotational energy is configured to insert the buoyant ball into a ball reset. The gravity and buoyancy engine also includes a ball reset. The ball reset includes a buoyant column, wherein the buoyant column is configured to lift the buoyant ball and a ball lift, wherein the ball lift is configured to move the buoyant ball from the buoyant column to the ball ramp.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a block diagram illustrating an example of a gravity and buoyancy engine;

FIG. 2 illustrates an example of a gravity and buoyancy engine;

FIG. 3 illustrates an example of a ball drop;

FIG. 4 illustrates an example of a drive wheel; and

FIG. 5 illustrates an example of a ball lift.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

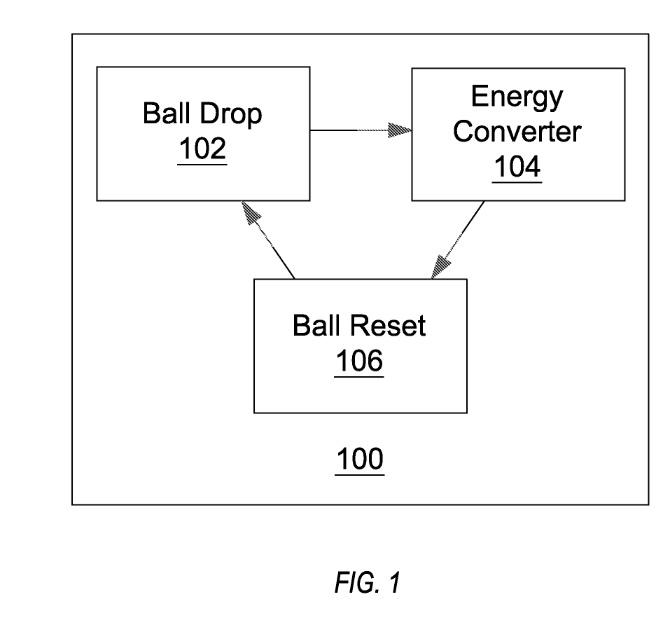

FIG. 1 is a block diagram illustrating an example of a gravity and buoyancy engine 100. In at least one implementation, the gravity and buoyancy engine 100 can covert gravitational potential energy into electricity. The gravitational potential energy can come in the form of downward acceleration of a body and buoyancy. I.e., gravitational potential energy can cause downward motion of a body or upward motion through buoyant forces which “push” the body upward.

In physics, buoyancy is a force exerted by a fluid that opposes an object's weight. In a column of fluid, pressure increases with depth as a result of the weight of the overlying fluid. Thus a column of fluid, or an object submerged in the fluid, experiences greater pressure at the bottom of the column than at the top. This difference in pressure results in a net force that tends to accelerate an object upwards. The magnitude of that force is proportional to the difference in the pressure between the top and the bottom of the column, and is also equivalent to the weight of the fluid that would otherwise occupy the column. For this reason, an object whose density is greater than that of the fluid in which it is submerged tends to sink. If the object is either less dense than the liquid or is shaped appropriately (as in a boat), the force can keep the object afloat. This can occur only in a reference frame which either has a gravitational field or is accelerating due to a force other than gravity defining a “downward” direction (that is, a non-inertial reference frame). In a situation of fluid statics, the net upward buoyancy force is equal to the magnitude of the weight of fluid displaced by the body.

FIG. 1 shows that the gravity and buoyancy engine 100 can include a ball drop 102. In at least one implementation, the ball can include any object which moves downward under the effect of gravity. I.e., the ball can include any object which is able to overcome the buoyant effect of the surrounding atmosphere. The ball can include a spherical object, which can allow for any orientation of the ball. The ball drop 102 can release the ball, either as it becomes available or according to a preset timing, which then acts under the effects of gravity. I.e., the ball drop 102 releases the ball, which then naturally converts gravitational potential energy into kinetic energy.

FIG. 1 also shows that the gravity and buoyancy engine 100 can include an energy convertor 104. In at least one implementation, the energy convertor 104 can convert the kinetic energy of the falling ball to other forms of energy. For example, the energy convertor 104 can include a generator, pump, motor or any other device capable of converting the motion of the ball into other energy, either potential or kinetic.

FIG. 1 further shows that the gravity and buoyancy engine 100 can include a ball reset 106. In at least one implementation, the ball reset 106 can return the ball to the ball drop 102. I.e., the ball reset can harness an energy source to return the ball to the ball drop 102 so that it can once again act under the force of gravity and produce additional energy.

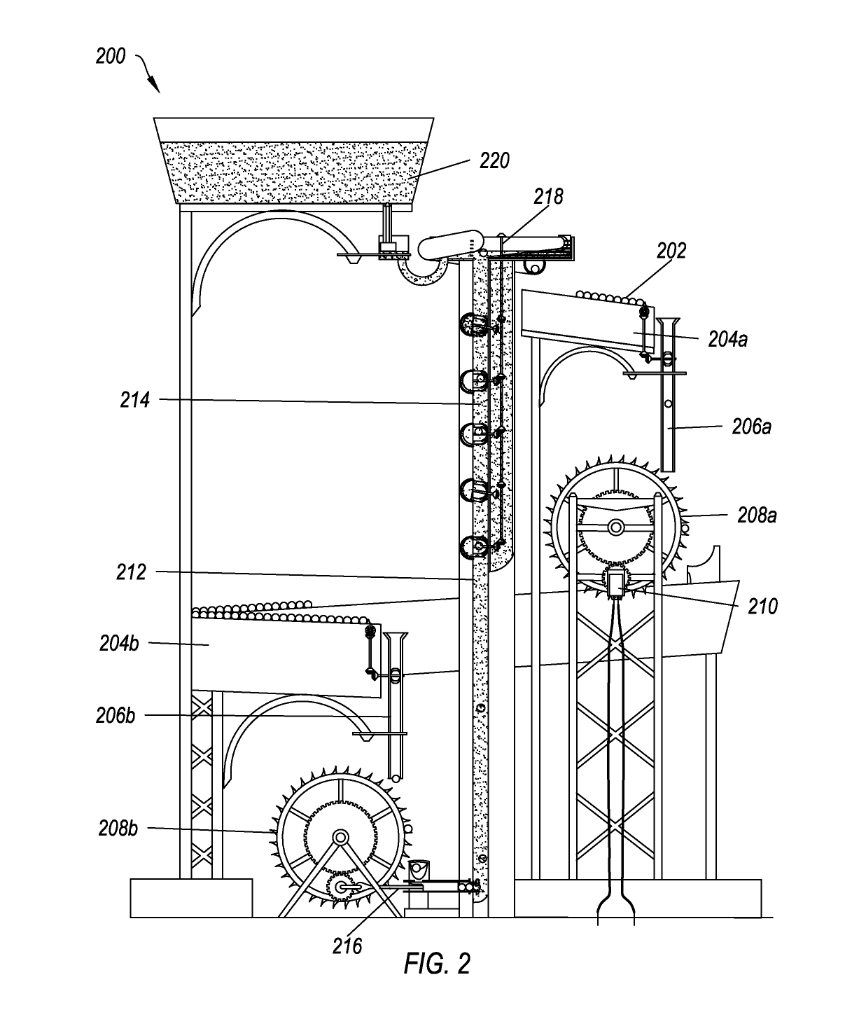

FIG. 2 illustrates an example of a gravity and buoyancy engine 200. In at least one implementation, the gravity and buoyancy engine 200 is configured to convert gravitational potential energy to energy that can be extracted from the system. In particular, the gravity and buoyancy engine 200 converts energy from a fluid which flows down under the force of gravity to usable energy.

FIG. 2 shows that the gravity and buoyancy engine 200 can include one or more buoyant balls 202. I.e., the buoyant balls 202 are configured to rise through the fluid used in the gravity and buoyancy engine 200, as discussed below. Additionally or alternatively, the buoyant balls 202 are configured to fall through the atmosphere in which the gravity and buoyancy engine 200 is operating. I.e., the buoyant balls 202 can fall under the force of gravity and rise due to buoyancy, as described below. The buoyant balls 202 can include a hollow central portion. I.e., the buoyant balls 202 can include a central portion which is filled with air or some other gas which decreases the density of the buoyant balls 202.

FIG. 2 also shows that the gravity and buoyancy engine 200 can include a first ball ramp 204a and a second ball ramp 204b (collectively “ball ramps 204”). In at least one implementation, the ball ramps 204 line up the buoyant balls 202 and prepare them to cycle through the gravity and buoyancy engine 200. I.e. the ball ramps 204 store the buoyant balls 202 until needed and present the buoyant balls 202 in the desired position when required.

FIG. 2 further shows that the gravity and buoyancy engine 200 can include a first drop tube 206a and a second drop tube 206b (collectively “drop tubes 206”). In at least one implementation, the drop tubes 206 allow the buoyant balls 202 to accelerate under the force of gravity. In particular, as the buoyant balls 202 fall the drop tubes 206 can ensure that the buoyant balls 202 fall the distance and path desired.

FIG. 2 additionally shows that the gravity and buoyancy engine 200 can include a first drive wheel 208a and a second drive wheel 208b (collectively “drive wheels 208”) can turn under the force of the falling buoyant balls 202. I.e., the buoyant balls 202 fall on a paddle or other portion of the drive wheels, causing the drive wheels 208 to turn. The turning drive wheels 208 can then be used to power other portions of the gravity and buoyancy engine 200 or to extract energy which can be output, as described below.

FIG. 2 also shows that the first drive wheel 208a can be connected to a generator 210. In at least one implementation, the generator 210 can produce electricity which can be output. I.e., the generator 210 can harness the energy of the turning drive wheel 208a and produce electricity which is output for any desired use. One of skill in the art will appreciate that the generator 210 can be replaced with any desired machine, such as a pump, motor or any other desired output device.

FIG. 2 further shows that the gravity and buoyancy engine 200 can include a buoyant column 212. In at least one implementation, the buoyant column 212 can be configured to return the buoyant balls 202 to their beginning position. In particular, the buoyant column 212 includes a buoyant fluid 214 which is movable under the influence of gravity. As gravity moves the buoyant fluid 214 downward, the buoyant fluid 214 displaces the buoyant balls 202 upward. The buoyant fluid 214 can include any desired fluid. For example, the buoyant fluid 214 can include water, oil or any other desired fluid.

FIG. 2 additionally shows that the gravity and buoyancy engine 200 can include a piston 216. In at least one implementation, the piston 216 can insert the buoyant balls 202 into the buoyant column 212. In particular, the piston 216 is articulated by the second drive wheel 208b. The articulating piston 216 can, in turn, move a buoyant ball 202 into the buoyant column 212, where it will be lifted by the buoyant fluid 214.

One of skill in the art will appreciate that other methods of inserting a buoyant ball 202 into the buoyant column 212 are contemplated herein. For example, the bottom of the buoyant column 212 can be isolated, using a horizontal divider or some other method. The buoyant fluid 214 can be removed from the bottom portion of the buoyant column 212 and the ball can be inserted. The isolation device can then be removed, allowing buoyant fluid 214 to enter the bottom portion of the buoyant column 212 and lift the buoyant ball 202.

Additionally or alternatively, vacuum pressure can be used to insert the buoyant ball 202 into the buoyant column 212. In particular, vacuum pressure can be used to raise the level of the buoyant fluid 214 within the buoyant column 212. The vacuum pressure then lifts the column, which means that inserting the buoyant ball 202 does not need to be used to raise the buoyant fluid 214 within the buoyant column 212.

FIG. 2 also shows that the gravity and buoyancy engine 200 can include a ball lift 218. In at least one implementation, the ball lift 218 can lift the buoyant balls 202 from the top of the buoyant column 212 and place them in the first ball ramp 204a. I.e., the buoyant balls float to the top of the buoyant column 212 where they are placed in the ball ramp 204a.

FIG. 2 further shows that the gravity and buoyancy engine 200 can include a fluid reservoir 220. In at least one implementation, the gravity and buoyancy engine 200 will lose small amounts of buoyant fluid 214 in each cycle. This loss is due to a variety of factors and eventually will lead to a ceasing of function. The fluid reservoir 220 can replace the fluid as lost, in order to allow the gravity and buoyancy engine 200 to continue to function. In particular, the buoyant fluid 214 moving down the column provides a force which is ultimately converted to energy which can be output. I.e., the buoyant fluid 214 exits the buoyant column 212 at the bottom when a buoyant ball 202 is placed in the buoyant column 212. Thus the buoyant fluid 214 moves from the top of the buoyant column to the bottom of the buoyant column 212, providing the energy for the gravity and buoyancy engine 200.

Additionally or alternatively, other sources of energy are contemplated herein. For example, a user can manually reset some of the balls, adding additional potential energy to the gravity and buoyancy engine 200, allowing it to continue to cycle and output energy. Additionally or alternatively, a water wheel or external engine can be attached to the second drive wheel 208b or to some other portion of the gravity and buoyancy engine 200. For example, the waterwheel can convert kinetic energy of moving water to motion of the engine, or the external engine can be powered in some manner which adds additional energy to the gravity and buoyancy engine 200.

By way of example, and not limitation, of one cycle of the gravity and buoyancy engine 200 will be provided. One of skill in the art will appreciate that the steps can be done in different order or can be modified. However, for illustrative purposes a single exemplary cycle will be described.

A buoyant ball 202 located in the first ball ramp 204a is released into the first drop tube 206a. The buoyant ball 202 moves the first drive wheel 208a, which produces electricity to be output by the generator 210. The buoyant ball 202 then exits the first drive wheel 208a and rolls down the second ball ramp 204a. The buoyant ball 202 is released into the second drop tube 206b and moves the second drive wheel 208b. The buoyant ball 202 exits the second drive wheel and is inserted into the buoyant column 212 by the piston 216. The buoyant fluid 214 exerts an upward force on the buoyant ball 202 which rises through the buoyant column 212. The buoyant ball 202 encounters the ball lift 218. The upward motion of the buoyant ball 202 allows the ball lift 218 to lift a buoyant ball 202 out of the buoyant fluid 214 into the first ball ramp 204a where the cycle begins anew.

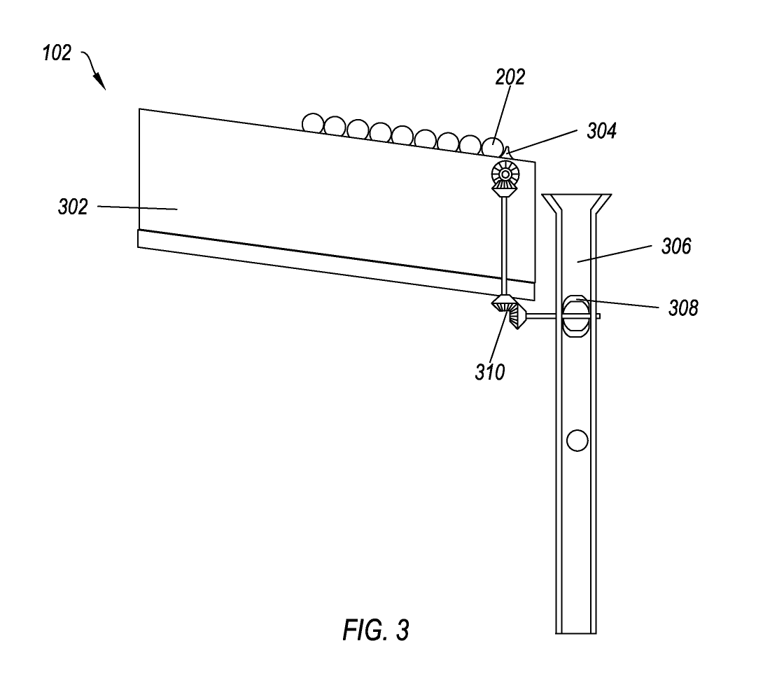

FIG. 3 illustrates an example of a ball drop 102. In at least one implementation, the ball drop 102 can control the rate and direction of the buoyant balls 202 as they drop. In particular, the ball drop 102 can control the timing of buoyant ball 202 releases, to ensure maximum efficiency. Additionally or alternatively, the ball drop 102 can direct the buoyant ball 202 to ensure that buoyant balls 202 engage the gravity and buoyancy engine as desired.

FIG. 3 shows that the ball drop 102 can include a ramp 302. In at least one implementation, the ramp 302 can include an inclined surface. The ramp 302 can ensure that that the position of at least one buoyant ball 202 is known. I.e., as long as one buoyant ball 202 is on the ramp 302, the buoyant ball 202 will seek the lowest location on the ramp 302, making its position known.

FIG. 3 also shows that the ball drop 102 can include a ball release 304. In at least one implementation, the ball release 304 can let the buoyant balls 202 exit the ramp 302 at the desired time. The timing can be controlled by when a mechanism will be available to “catch” the released buoyant ball 202, by when a prior ball has passed a pre-selected point or any other desired timing. The ball release 304 can include a rotor or other mechanism which releases only a single ball. Additionally or alternatively, the ball release 304 can include a ratchet mechanism which is released and allows a single buoyant ball 202 to pass through when desired.

FIG. 3 further shows that the ball drop 102 can include a tube 306. In at least one implementation, the tube 306 can control the direction of the buoyant balls 202 as they drop. I.e., the tube 306 can ensure that the buoyant balls 202 follow the desired path as they drop. Additionally or alternatively, the tube 306 can ensure that the buoyant balls 202 attain the proper drop speed. I.e., the longer the tube 306, the more momentum obtained by the buoyant balls 202. Therefore, the length of the tube 306 can affect the amount of energy obtained.

FIG. 3 additionally shows that the ball drop 102 can include a tube rotor 308. In at least one implementation, the tube rotor 308 can be rotated by the buoyant ball 202 falling through the tube 306. I.e., the falling buoyant ball 202 engages and rotates the tube rotor 308. The tube rotor 308, in turn, triggers the ball release 304, releasing the next buoyant ball 202. One of skill in the art will appreciate that the placement of the tube rotor 308 can determine the rate at which buoyant balls 202 drop. For example, lowering the position of the tube rotor 308 can increase the time between the release of the buoyant balls 202. In contrast, raising the position of the tube rotor 308 can decrease the time between the release of the buoyant balls 202.

FIG. 3 also shows that the ball drop 102 can include a linkage 310. In at least one implementation, the linkage 310 can connect the tube rotor 308 to the ball release 304. In particular, the linkage 310 can transmit rotation of the tube rotor 308 to the ball release 304. I.e., the buoyant ball 202 falls through the tube 306 and engages the tube rotor 308. The tube rotor 308 begins to rotate, which is transmitted through the linkage 310 to the ball release 304, which also rotates. As the ball release 304 rotates, it releases an additional buoyant ball 202 which drops through the tube 306.

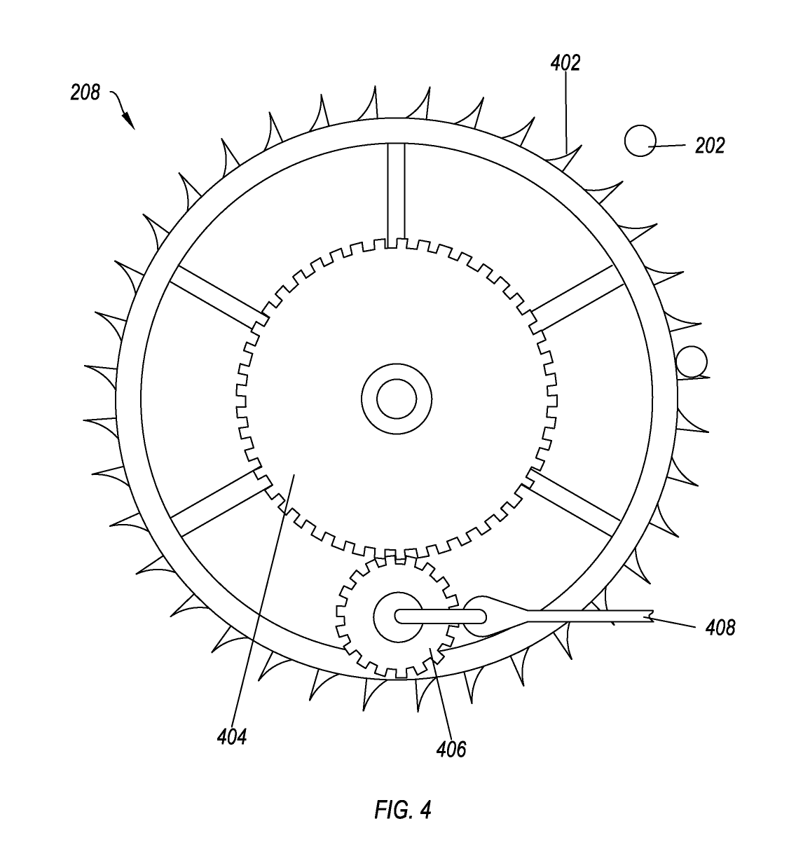

FIG. 4 illustrates an example of a drive wheel 208. In at least one implementation, the drive wheel 208 is configured to convert the kinetic energy of a dropping buoyant ball 202 to usable energy. For example, the drive wheel 208 can convert the kinetic energy to electrical energy. Additionally or alternatively, the drive wheel 208 can convert the kinetic energy to work or other desired energy. For example, the drive wheel 208 can drive a motor, pump or other device which performs desired work.

FIG. 4 shows that the drive wheel 208 can include one or more paddles 402. In at least one implementation, the one or more paddles 402 are configured to “catch” the dropping buoyant ball 202. I.e., the one or more paddles 402 are configured to receive the buoyant ball 202 and transfer the kinetic energy of the buoyant ball 202 to the drive wheel 208.

FIG. 4 also shows that the drive wheel 208 can include a first gear 404. In at least one implementation, the first gear 404 can include a rotating machine part having cut teeth, or cogs, which mesh with another toothed part in order to transmit torque. The first gear 404 can be turned by the drive wheel 208. That is, a single rotation of the drive wheel 208 can result in a single rotation of the first gear 404.

FIG. 4 further shows that the drive wheel 208 can include a second gear 406. In at least one implementation, the second gear 406 can be rotated by the first gear 404. The ratio of the rotation speed of the second gear 406 to the first gear 404 is determined by the gear ratio. The gear ratio of a gear train is the ratio of the angular velocity of the input gear to the angular velocity of the output gear, also known as the speed ratio of the gear train. The gear ratio can be computed directly from the numbers of teeth of the first gear 404 and the second gear 406. The torque ratio of the gear train, also known as its mechanical advantage, is defined by the gear ratio.

FIG. 4 additionally shows that the drive wheel 208 can include a load 408. In at least one implementation, the load 408 is a device which receives the energy output of the drive wheel 208. For example, the load 208 can include an electrical converter, which outputs electrical power. Additionally or alternatively, the load can include a mechanical device, which does work. For example, the load 208 can include a piston for pushing buoyant balls 202 into a buoyant column, as described above.

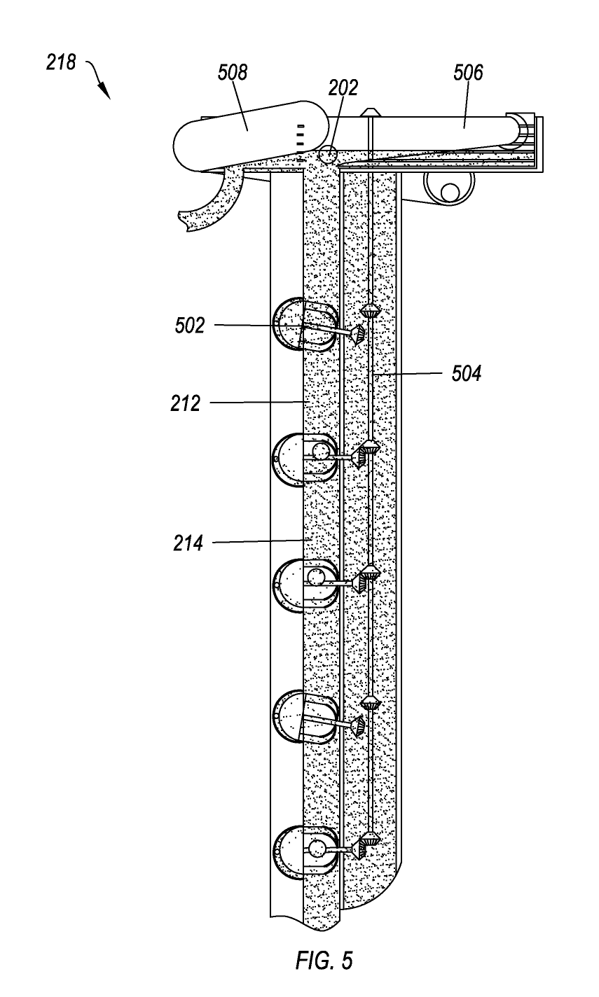

FIG. 5 illustrates an example of a ball lift 218. In at least one implementation, the ball lift 218 is configured to lift a buoyant ball 202 from a buoyant column 212. That is, the ball lift 218 is configured to transmit the buoyant force on a first buoyant ball 202 by the buoyant fluid 214 to a second buoyant ball 202 which is lifted out of the buoyant fluid 214. The first buoyant ball 202 then continues to the top of the buoyant column 212 where it is removed from the buoyant fluid 214.

FIG. 5 shows that the ball lift 218 can include one or more column rotors 502. In at least one implementation, the one or more column rotors 502 are rotated and lifted by the buoyant balls 202 as they rise through the buoyant column 212. For example, the one or more column rotors 502 can be approximately neutrally buoyant with regard to the buoyant fluid 214. In addition, the one or more column rotors 502 can be attached to the buoyant column 212 at a first end (the left side as shown in FIG. 5). As a buoyant ball 202 rises through the buoyant column 212 the buoyant ball 202 rotates the column rotor 502 and lifts the unattached end.

FIG. 5 also shows that the ball lift 218 can include a lift shaft 504. In at least one implementation, the lift shaft 504 is rotated by the one or more column rotors 502. In particular, the one or more column rotors 502 can include a cog on their free end which is configured to interact with cogs on the lift shaft 504. As the one or more column rotors 502 are turned by the buoyant balls 202, the rotation is transferred to the lift shaft 504.

FIG. 5 further shows that the ball lift 218 can include a lift rotor 506. In at least one implementation, the lift rotor 506 can lift the buoyant balls 202. For example, the lift rotor 506 can spin, pushing the buoyant balls 202 up a ramp and out of the buoyant fluid 216. Additionally or alternatively, the lift rotor 506 can rotate on an axis parallel to the top surface of the buoyant fluid 216 such that portions of the lift rotor 506 rise above the top surface of the buoyant fluid 216.

FIG. 5 additionally shows that the ball lift 218 can include an exit tube 508. In at least one implementation, the exit tube 508 is configured to receive a buoyant ball 202 that has been lifted from the buoyant fluid 216 by the lift rotor 506. For example, after the buoyant ball 202 has been pushed up a ramp by the lift rotor 506 the buoyant ball 202 can be pushed into the exit tube 508.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A gravity and buoyancy engine, the gravity and buoyancy engine comprising:
a ball drop, wherein the ball drop is configured to release a ball to fall under the force of gravity;
an energy converter, wherein the energy convertor is configured to convert the energy of the falling body into energy that is output from the gravity and buoyancy engine; and
a ball reset, wherein the ball reset is configured to lift the ball to the initial release point.

2. The gravity and buoyancy engine of claim 1, wherein the ball reset includes a buoyant fluid, wherein the buoyant fluid is more dense than the ball.

3. The gravity and buoyancy engine of claim 2, wherein the buoyant fluid includes water.

4. The gravity and buoyancy engine of claim 2, wherein the buoyant fluid includes oil.

5. The gravity and buoyancy engine of claim 2, wherein the ball reset includes a buoyant column, wherein the buoyant column is configured to receive the buoyant fluid.

6. The gravity and buoyancy engine of claim 2, wherein buoyant fluid is raised using vacuum pressure before the buoyant ball is inserted.

7. The gravity and buoyancy engine of claim 1, wherein the buoyant ball includes a central portion, wherein the central portion includes air.

8. The gravity and buoyancy engine of claim 1, wherein the ball drop includes a ball ramp.

9. The gravity and buoyancy engine of claim 1, wherein the ball drop includes a drop tube, wherein the drop tube is configured to receive a buoyant ball from the ball ramp.

10. The gravity and buoyancy engine of claim 1, wherein the energy convertor includes a generator, wherein the generator is configured to convert mechanical motion into electrical power.

11. A gravity and buoyancy engine, the gravity and buoyancy engine comprising:
a ball drop, wherein the ball drop:
is configured to release a buoyant ball to fall under the force of gravity; and
includes:
a ball ramp, wherein the ball ramp is configured to release the buoyant ball; and
a drop tube, wherein the drop tube is configured to receive the buoyant ball from the ball ramp and direct the path of the falling buoyant ball;
a drive wheel, wherein the drive wheel is configured to:
receive the falling buoyant ball from the drop tube; and
convert the kinetic energy of the falling buoyant ball to rotational energy, wherein the rotational energy is converted to energy which is output from the gravity and buoyancy engine; and
a ball reset, wherein the ball reset includes:
a buoyant column, wherein the buoyant column is configured to lift the buoyant ball; and
a ball lift, wherein the ball lift is configured to move the buoyant ball from the buoyant column to the ball ramp.

12. The gravity and buoyancy engine of claim 11, wherein the ball lift includes a lift rotor.

13. The gravity and buoyancy engine of claim 12, wherein the ball lift includes a lift shaft, wherein the lift shaft is configured to turn the lift rotor.

14. The gravity and buoyancy engine of claim 13, wherein the ball lift includes a column rotor, wherein the column rotor converts the upward motion of the buoyant ball through the buoyant column into rotation of the lift shaft.

15. The gravity and buoyancy engine of claim 14, wherein the column rotor includes a cog, wherein the cog is configured to transfer rotational motion of the column rotor to rotational motion of the lift shaft.

16. The gravity and buoyancy engine of claim 15, wherein the ball lift includes a ramp, wherein at least one paddle connected to the lift rotor moves the buoyant ball along the ramp.

17. The gravity and buoyancy engine of claim 11, wherein the output energy is electrical power.

18. A gravity and buoyancy engine, the gravity and buoyancy engine comprising:
a first ball drop, wherein the first ball drop:
is configured to release a buoyant ball to fall under the force of gravity; and
includes:
a first ball ramp, wherein the first ball ramp is configured to release the buoyant ball; and
a first drop tube, wherein the first drop tube is configured to receive the buoyant ball from the first ball ramp and direct the path of the falling buoyant ball;
a first drive wheel, wherein the first drive wheel is configured to:
receive the falling buoyant ball from the drop tube; and
convert the kinetic energy of the falling buoyant ball to rotational energy, wherein the rotational energy is converted to electrical energy which is output from the gravity and buoyancy engine; and
a second ball drop, wherein the second ball drop includes:
a second ball ramp, wherein the second ball ramp is configured to receive a buoyant ball from the first drive wheel; and
a second drop tube, wherein the second drop tube is configured to receive the buoyant ball from the second ball ramp and direct the path of the falling buoyant ball;
a second drive wheel, wherein the second drive wheel is configured to:
receive the falling buoyant ball from the drop tube; and
convert the kinetic energy of the falling buoyant ball to rotational energy, wherein the rotational energy is configured to insert the buoyant ball into a ball reset; and
the ball reset, wherein the ball reset includes:
a buoyant column, wherein the buoyant column is configured to lift the buoyant ball; and
a ball lift, wherein the ball lift is configured to move the buoyant ball from the buoyant column to the ball ramp.

19. The gravity and buoyancy engine of claim 18, further comprising a piston, wherein the piston is configured to use the rotation energy of the second drive wheel to insert the buoyant ball into the buoyant column.

20. The gravity and buoyancy engine of claim 18, wherein the first drive wheel includes a paddle, wherein the paddle is configured to receive the buoyant ball and transfer the kinetic energy of the buoyant ball to the drive wheel.
